(19) United States
(12) Patent Application Publication
(10) Pub. No.: US 2017/0034378 A1
(43) Pub. Date: Feb. 2, 2017

(54) IMAGE PROCESSING APPARATUS, IMAGE PROCESSING APPARATUS CONTROL METHOD, AND STORAGE MEDIUM

(71) Applicant: CANON KABUSHIKI KAISHA, Tokyo (JP)

(72) Inventor: Toyomi Hirao, Kashiwa-shi (JP)

(21) Appl. No.: 15/218,912

(22) Filed: Jul. 25, 2016

(30) Foreign Application Priority Data
Jul. 28, 2015 (JP) 2015-148330

(51) Int. Cl. H04N 1/00; G06K 15/00; H04N 1/047

(52) U.S. Cl. CPC H04N 1/00814; H04N 1/047; H04N 1/00084; G06K 15/4085; H04N 2201/04767

(57) ABSTRACT

An image processing apparatus performs recovery processing for recovering a reading error when a predetermined condition is satisfied. The image processing apparatus includes a reading unit configured to read a document, a printing unit configured to print an image of the document read by the reading unit, and a processing unit configured to perform recovery processing for recovering a reading error by the reading unit if a mode for concurrently implementing the reading by the reading unit and the printing by the printing unit is not set.

### BACKGROUND OF THE INVENTION

Field of the Invention

The present invention relates to an image processing apparatus, an image processing apparatus control method, and a storage medium.

Description of the Related Art

If an abnormality occurs in a document image reading operation, an image forming apparatus interrupts the reading operation and performs error processing. Then, the image forming apparatus performs a re-reading operation, as is generally known. The abnormality in the reading operation may be a paper jam occurring when a document is conveyed, which requires a paper removal operation to be performed by a user, or may be an abnormality of an image transfer signal due to noise.

Especially, in many cases, the image signal abnormality due to noise can be easily eliminated by performing the reading operation again. Accordingly, causing the image forming apparatus to start re-reading processing immediately or automatically without waiting for a reading retry instruction from a user is desired when the image transfer signal abnormality is detected. There is a conventional image forming apparatus that has the above-mentioned re-reading function.

Further, an image forming apparatus capable of concurrently implementing image reading processing and image print processing (which is referred to as “FCOT mode”) in a read document image print and output operation, is conventionally known. A technique capable of realizing the above-mentioned method is discussed in Japanese Patent Application Laid-Open No. 2001-69318. Similarly, an image forming apparatus operable in a successive transmission mode (hereinafter, referred to as “direct transmission mode”), which can concurrently implement document reading processing and transmission processing in a facsimile transmitting operation, is conventionally known.

If an image signal abnormality occurs due to noise in the image forming apparatus having the above-mentioned configuration, error recovery that can be realized by retrying the reading processing is desired by a user who uses the image forming apparatus. However, the above-mentioned automatic error recovery processing may be repeated a plurality of times before the reading processing for a piece of a reading target document is completed. In general, the number of read document sheets is counted only when the processing is completed normally.

On the other hand, mechanical components, such as a motor and a flapper, equipped in the image forming apparatus, are moved or driven regardless of normal termination or abnormality termination of the scan processing.

Accordingly, the number of times the operations of the mechanical components (e.g., the motor and the conveyance path switching flapper) are utilized may not coincide with the number of actually read document sheets. In a case where the timing of exchanging a consumable component (e.g., the motor) is managed with reference to the number of read document sheets, retrying the reading processing will not be desired because the number of read document sheets will not be equal to the number of mechanical operations. In such circumstances, the exchange timing of each consumable component cannot be accurately managed.

Further, in an assembling process of a factory, a worker may perform a reading operation to confirm whether electric power is normally supplied to a reading unit. In this situation, if the retry processing is performed, the reading operation will be performed a plurality of times. The time required to confirm the power supply status will become longer. The time required to accomplish the assembling will become longer, correspondingly.

### SUMMARY OF THE INVENTION

An image processing apparatus according to the present invention includes a reading unit configured to read a document, a printing unit configured to print an image of the document read by the reading unit, and a processing unit configured to perform recovery processing for recovering a reading error by the reading unit if a mode for concurrently implementing the reading by the reading unit and the printing by the printing unit is not set.

Further features of the present invention will become apparent from the following description of exemplary embodiments with reference to the attached drawings.

### BRIEF DESCRIPTION OF THE DRAWINGS

FIG. 1 is a block diagram illustrating a configuration of an image forming apparatus.

FIG. 2 is a plan view illustrating an exemplary configuration of a reading unit illustrated in FIG. 1.

FIG. 3 is a cross-sectional side view illustrating an internal configuration of a document feeder (DF) unit.

FIGS. 4A and 4B are timing charts illustrating reading signals output by a contact image sensor (CIS).

FIGS. 5A and 5B illustrate an exemplary configuration of an image processing application specific integrated circuit (ASIC).

FIG. 6 is a flowchart illustrating a method for controlling the image forming apparatus.

FIG. 7 is a flowchart illustrating a method for controlling the image forming apparatus.

FIGS. 8A, 8B, and 8C illustrate configuration information.

FIGS. 9A and 9B illustrate examples of job information.

FIG. 10 illustrates an exemplary user interface (UI) screen that can be displayed by the image forming apparatus.

FIG. 11 is a flowchart illustrating a method for controlling the image forming apparatus.

FIG. 12 illustrates an exemplary UI screen that can be displayed by the image forming apparatus.

FIG. 13 illustrates an exemplary UI screen that can be displayed by the image forming apparatus.

FIG. 14 illustrates an exemplary UI screen that can be displayed by the image forming apparatus.

FIG. 15 is a flowchart illustrating a method for controlling the image forming apparatus.

FIG. 16 illustrates an exemplary UI screen that can be displayed by the image forming apparatus.

### DESCRIPTION OF THE EMBODIMENTS

The best mode for embodying the present invention will be described in detail below with reference to the attached drawings.

### <System Configuration>

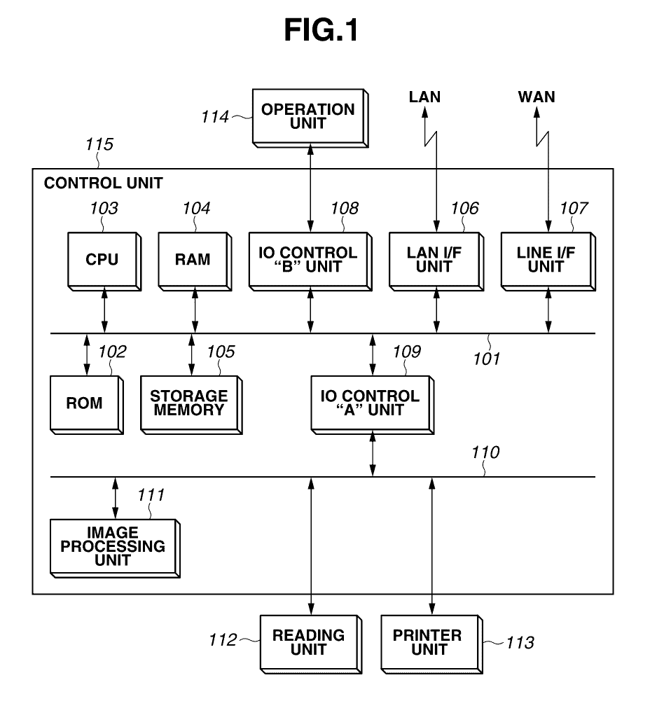

FIG. 1 is a block diagram illustrating an exemplary configuration of an image forming apparatus according to one embodiment of the present invention.

Hereinafter, a first exemplary embodiment will be described in detail below. The image forming apparatus illustrated in FIG. 1 includes a control unit 115, which is constituted by various hardware components connected to a system bus 101 or an image bus 110. A read only memory (ROM) 102 stores a system boot program. System software programs, which can realize various units according to the present invention, are stored in the ROM 102 or a storage memory 105. A central processing unit (CPU) 103 can execute the system software programs. A random access memory (RAM) 104 serves as a system work memory when the CPU 103 executes the software programs. Further, the RAM 104 is operable as an image memory that temporarily stores image data to be processed.

The storage memory 105 can be used as an internal storage that stores data read by a reading unit, image data, and the system software programs. The storage memory 105 can be constituted by a hard disk drive (HDD) or a solid state drive (SSD).

The storage memory 105 includes a plurality of sectioned compartments, each of which can store image data of a read document. Further, a counter file that stores a counter value to record the number of scanned and read document sheets is provided in the storage memory 105.

The above-mentioned configuration includes the counter file, which stores the counter value, in the storage memory 105. However, providing the counter file is not essentially required for management. For example, a non-volatile static random access memory (SRAM) is available to record the counter value. Further, a configuration file that can store setting information about the image forming apparatus is provided on the storage memory 105, in addition to the counter file. The configuration file is a data file that can constitute a database, such as a relational database.

When the image forming apparatus starts an operation, acquiring necessary setting information with reference to setting values stored in the configuration file is required. In general, setting value information can be updated by a user operation or can be automatically updated by the image forming apparatus. The updated setting value information can be stored in the configuration file.

A local area network (LAN) I/F unit 106 is an interface (I/F) unit that can connect the control unit 115 to the LAN, so that the image forming apparatus can input or output information (or data) from or to each device connected to the LAN. The above-mentioned hardware devices are disposed on the system bus 101. An IO control “A” unit 109 is a bus bridge that connects the system bus 101 to the image bus 110, which can speedily transfer image data, and is capable of converting the data configuration of the system bus 101.

The image bus 110 can be constituted by a general purpose bus, such as PCI bus, IEEE1394, or PCIEx. The following devices are disposed on the image bus 110. A reading unit 112 (i.e., an image input/output device), a printer unit 113, and an image processing unit 111 are connected to the image bus 110 to realize a synchronous/asynchronous conversion of image data.

The image processing unit 111 can perform image processing, such as resolution conversion, compression/expansion, and binary to multi-value conversion, on image data to be input and output. Further, the image processing unit 111 can control processing for receiving image data from the reading unit and transferring the received image data to the RAM 104 via the image bus 110 and the system bus 101. The image processing unit 111 can be realized by an image processing ASIC (hardware) and a software program running on the CPU 103 to control the processing to be performed by the image processing ASIC.

The image processing ASIC includes registers, which are respectively usable to set the format of data to be processed and processing contents. The control software program running on the CPU 103 performs various settings on the registers of the image processing ASIC so that the image processing unit 111 can perform the image processing. An IO control “B” unit 108 is an interface unit dedicated to an operation unit 114 (i.e., a user interface (UI)), which can output image data to be displayed on the operation unit 114 that displays an image based on the received image data.

Further, if a user of the system inputs information via the operation unit 114, the IO control “B” unit 108 transmits the input information to the CPU 103. In other words, the IO control “B” unit 108 is an I/F unit that the software program can use to control the operation unit 114 on which a display device and a keypad device are provided.

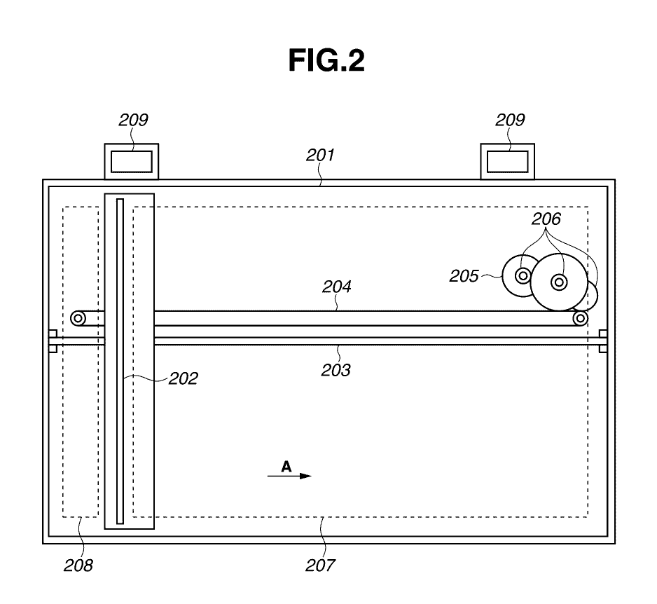

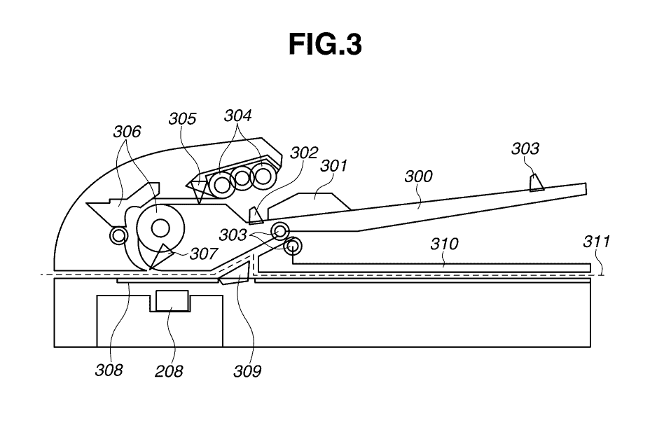

In the present exemplary embodiment, the operation unit 114 is constituted by a liquid crystal display (LCD) touch panel. The operation unit 114 interprets a video graphics array (VGA) signal output from the IO control “B” unit 108 and performs a screen display based on the interpreted VGA signal. The reading unit 112 will be described in detail below with reference to FIGS. 2 and 3. The reading unit 112 is constituted by a scanner unit and a document feeder (DF). The scanner unit will be described in detail below with reference to FIG. 2.

FIG. 2 is a plan view illustrating an exemplary configuration of the reading unit 112 illustrated in FIG. 1.

As illustrated in FIG. 2, a reference shaft 203 is provided in a frame body 201. The reference shaft 203 regulates a sensor unit 202 so that the sensor unit 202 can move in a sub scanning direction (i.e., the direction of arrow A). A flat bed (FB) reading stepping motor 205 (hereinafter, simply referred to as “stepping motor”) generates a driving force, which can be transmitted to a belt 204 via a gear group 206. The belt 204 causes the sensor unit 202 to move along the reference shaft 203.

A document positioning glass 207, on which a document can be placed, and a DF reading window 308 usable for DF scanning are provided in the frame body 201. The DF reading window 308 is similar to the document positioning glass 207 and is made of a material that can transmit light emitted from a light emitting diode (LED) serving as a light source. The sensor unit 202 can freely move in a predetermined region including the document positioning glass 207 and the DF reading window 308. When the reading unit receives a scanning command from the control unit 115, the reading unit drives the stepping motor 205 to drive the belt 204 via the gear group 206.

Therefore, the sensor unit 202 can move in the sub scanning direction along the reference shaft 203 and read the document placed on the document positioning glass 207. The DF unit will be described in detail below with reference to FIG. 3.

FIG. 3 is a cross-sectional side view illustrating an internal configuration of the DF unit of the reading unit 112 illustrated in FIG. 1. As illustrated in FIG. 3, the DF unit includes a document tray 300 on which a document to be read can be placed. A document sensor 302 that can detect the presence of a document, two document guides 301, and a document size detection sensor 303 are provided on the document tray 300. Two document guides 301 are placed each other in a direction perpendicular to the document conveyance direction and arrayed in such a way as to support the document along the vertical direction thereof. The document placed on the document tray 300 can be conveyed by pickup rollers 304, conveyance rollers 306, and discharge rollers 303.

The pickup rollers 304 can convey the document placed on the document tray 300 into an internal document conveyance passage of the DF unit. Following the conveyance of the document by the pickup rollers 304, the conveyance rollers 306 can convey the document along the internal document conveyance passage. Following the conveyance of the document by the conveyance rollers 306, the discharge rollers 303 can convey the document to a discharge tray 310.

Further, the document conveyed by the pickup rollers 304 can be detected by a document passage detection sensor 305. It is feasible to determine whether the first document sheet has entirely passed with reference to a detection time acquired by the document passage detection sensor 305. Although not illustrated, the conveyance rollers 306, the pickup rollers 304, and the discharge rollers 303 can be driven by the stepping motor 205. The DF unit can realize sub scanning thinning-out processing by doubling the frequencies of driving pulses to be supplied to the above-mentioned conveyance, pickup, and discharge rollers, in the same manner as the scanner unit that doubles the frequency of an input signal to the stepping motor 205. The document conveyed by the DF unit passes through the DF reading window 308 and read by a CIS 208 equipped in the sensor unit 202 and located beneath the DF reading window 308.

The sensor unit 202 equipped with the CIS 208 is freely movable in the sub scanning direction as mentioned above. The sensor unit 202 is also movable in a direction identical to the conveyance direction of the document conveyed from the conveyance rollers 306 to the discharge rollers 303. The DF reading window 308 has a significant length in the sub scanning direction. Therefore, within the length range of the DF reading window 308, the CIS 208 can move to an arbitrary position and perform a document reading operation at the arbitrary position.

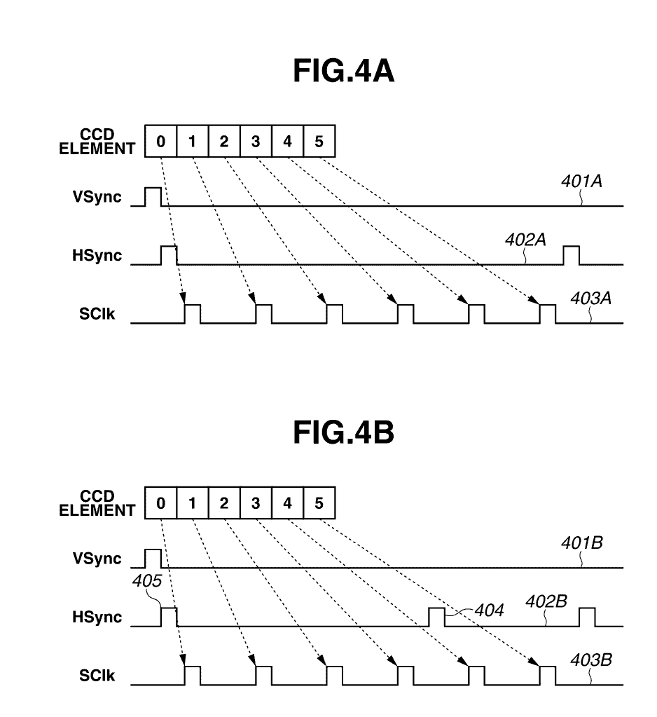

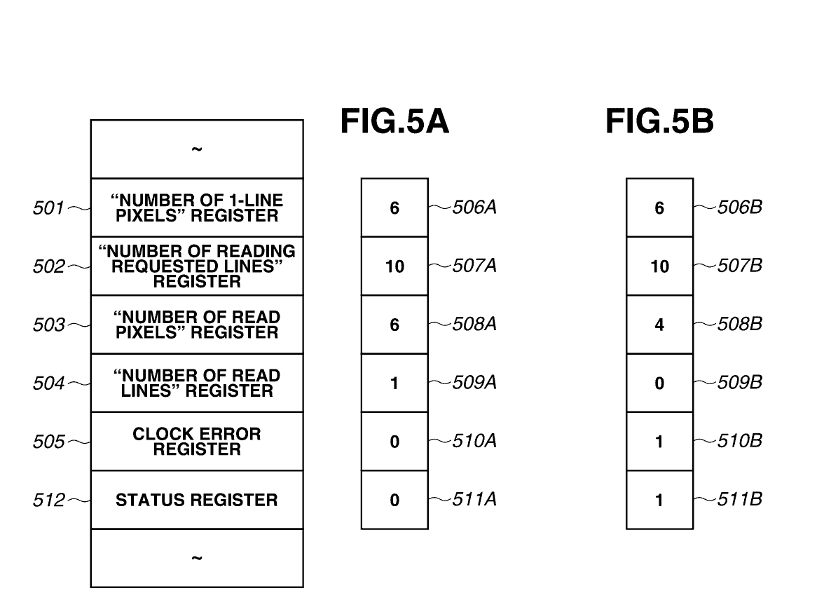

The CIS 208 can be constituted by photoelectric conversion elements, such as charge-coupled devices (CCDs). The CIS 208 can simultaneously perform FIFO processing for storing images of respective elements and generate signals for controlling the FIFO processing and the photoelectric conversion elements. In general, the CIS 208 can be realized by a plurality of photoelectric conversion elements arrayed in a row. A method for transferring read data to the control unit 115 and a method for detecting a data transfer error in a reading operation will be described in detail below with reference to FIGS. 4A and 4B and FIGS. 5A and 5B.

FIGS. 4A and 4B are timing charts illustrating reading signals output from the CIS 208 illustrated in FIG. 2.

To simplify the description of the present exemplary embodiment, it is assumed in the below description that the CIS 208 is constituted by six photoelectric conversion elements. However, the number of the photoelectric conversion elements is not limited to 6.

The method described in the present exemplary embodiment includes detecting abnormality of an HSync signal with reference to the number of 1-line pixels and a 1-line sync signal. However, the description does not intend to limit the present invention to processing relating to abnormality detection of an Hsync signal 402(A). The present invention is applicable to similar processing for VSync signal 401(A), Sclk signal 403, or any clock relating to the data transfer. Further, there are various types of signal abnormality detection methods, which can be employed as an error detection method according to the present invention.

When the control unit 115 performs an image reading operation, the control software program running on the CPU 103 performs settings for the registers of the image processing ASIC that constitute the image processing unit 111 with respect to the number of pixels of an image to be read by the photoelectric conversion element and the number of lines. In the present exemplary embodiment, each photoelectric conversion element is configured to read six pixels. Therefore, the control unit 115 performs the reading operation for each of the six pixels. However, the number of pixels to be read is not limited to 6.

FIGS. 5A and 5B illustrate exemplary registers of the image processing ASIC.

As illustrated in FIGS. 5A and 5B, when the control unit 115 starts a reading operation, the control unit 115 sets “6” as a numerical value indicating the number of pixels to be read in a “number of 1-line pixels” register 501. Similarly, the control unit 115 sets a numerical value indicating the number of lines to be read in a “number of reading requested lines” register 502. After completing the above-mentioned register settings, the control unit 115 transmits an image reading instruction to the reading unit 112 together with information about the number of pixels and the number of lines to be read.

In the present exemplary embodiment, it is assumed that the number of pixels to be read is “6” and the number of lines to be read is “5.” However, the number of pixels to be read and the number of lines to be read are not limited to specific values. The number of lines and the number of pixels can be appropriately determined unless the determined numbers exceed the capacity or the number of the photoelectric conversion elements that constitute the CIS 208 or FIFO.

When the reading unit 112 receives the image reading instruction from the control unit 115, the reading unit 112 generates VSync 401(A) or 401(B) signal that indicates starting a data reading operation and outputs data of the photoelectric conversion elements 0 to 5 of the CIS 208, to the FIFO within the CIS 208. In response to the VSync signal 401(A), the image processing ASIC of the image processing unit 111 initializes the numerical value in a “number of read lines” register 504 to “0.” Further, similarly, the image processing ASIC initializes the numerical values in a clock error register 505 and a status register 512 to “0.” The clock error register 505 is usable to detect whether an error has occurred in an image reading operation.

The CIS 208 outputs the HSync signal 402(A) representing the head of the line and gives an instruction to start transferring 1-line data. Further, as illustrated in FIGS. 4A and 4B, the CIS 208 outputs data of the photoelectric conversion element 0 stored in the FIFO to the image bus 110. In response to the HSync signal 402(A), the image processing ASIC of the image processing unit 111 initializes the numerical value in a “number of read pixels” register 503 to “0.” The above-mentioned initialization of the “number of read pixels” register 503 is performed every time when the HSync signal is received. The number of read pixels is reset for each line. After the FIFO data is output to the image bus 110, the CIS 208 outputs a Sclk signal 403(A) and notifies that the signal of one pixel has been output to the image bus 110.

In response to the Sclk signal, the image processing ASIC of the image processing unit 111 acquires the data of one pixel from the image bus 110 and transfers the acquired data to the RAM 104. If the data transfer to the RAM 104 is completed, the image processing ASIC counts up the numerical value of the “number of read pixels” register 503 by one and records that the reading of one pixel has been completed. The CIS 208 repeats the above-mentioned processing for reading the data of the photoelectric conversion element from the FIFO and outputting the read data to the image bus 110 and then outputting the Sclk signal, a number of the reading requested pixels times. Similarly, in response to the Sclk signal, the image processing ASIC of the image processing unit 111 acquires data of one pixel and transfers the acquired data to the RAM 104 and then counts up the numerical value of the “number of read pixels” register 503.

The image processing ASIC of the image processing unit 111 repeats the above-mentioned processing until the numerical value of the “number of read pixels” register 503 becomes equal to the numerical value of the “number of 1-line pixels” register 501. If the numerical value of the “number of read pixels” register 503 becomes equal to the numerical value of the “number of 1-line pixels” register 501, the image processing ASIC of the image processing unit 111 does not transfer the data to the RAM 104 even when the Sclk signal 403(A) is input.

Further, the image processing ASIC of the image processing unit 111 does not perform count-up processing for the “number of read pixels” register 503. When the data output of the reading requested pixels is completed, the CIS 208 causes the conveyance rollers 306 or the stepping motor 205 to rotate so that the CIS 208 or the document can reach a reading position of the next line.

After the above-mentioned movement is completed, the CIS 208 stores data of the photoelectric conversion elements 0 to 5 in the FIFO similarly. After the storage of data into the FIFO is completed, the CIS 208 outputs the HSync signal 402 and notifies the image processing unit 111 of shifting of the image data into the next line. In response to the HSync signal received from the CIS 208, the image processing ASIC of the image processing unit 111 confirms whether the numerical value of the “number of read pixels” register 503 is equal to the numerical value of the “number of 1-line pixels” register 501. The above-mentioned processing is referred to as “number of read pixels” comparison processing.

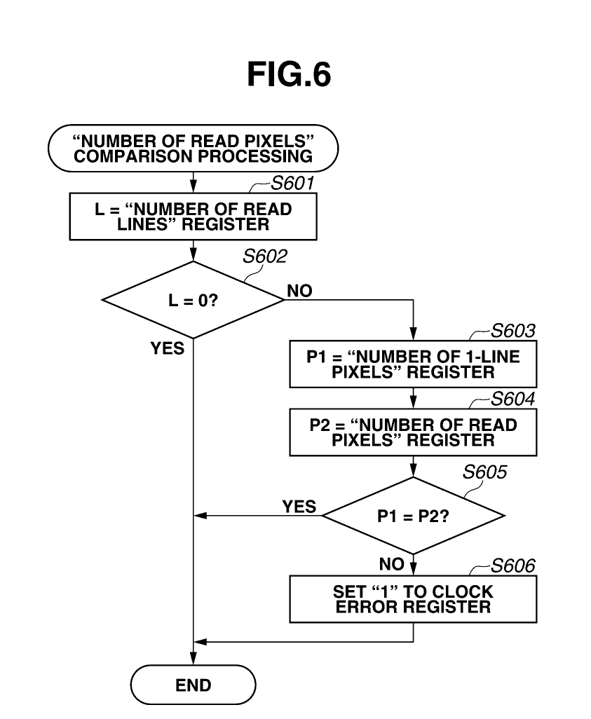

The “number of read pixels” comparison processing can be realized by the hardware that constitutes the image processing ASIC of the image processing unit 111. The “number of read pixels” comparison processing will be described in detail below with reference to a flowchart illustrated in FIG. 6.

FIG. 6 is a flowchart illustrating a method for controlling the image processing apparatus according to one embodiment. Processing illustrated in FIG. 6 corresponds to the “number of read pixels” comparison processing according to the present exemplary embodiment, for example. To realize processing in each step, the CPU 103 executes a control program stored beforehand.

First, in step S601, the CPU 103 reads the numerical value recorded in the “number of read lines” register 504 as L(=5). After the reading processing has been completed, the operation proceeds to step S602. In step S602, the CPU 103 determines whether the value L representing the recorded value of the “number of read lines” register 504 is zero. The processing of step S602 is required to prevent the clock error from being always detected in a state where the “number of read pixels” register 503 and the “number of read lines” register 504 are initialized at the input timing of the HSync signal 402 that immediately follows the VSync signal 401.

If the HSync signal 402 of the second or subsequent line (L≧1) is input (NO in step S602), the operation proceeds to step S603. In step S603, the CPU 103 reads the numerical value of the “number of 1-line pixels” register 501 as P1. In step S604, the CPU 103 reads the numerical value of the “number of read pixels” register 503 as P2.

In step S605, the CPU 103 compares the numerical values of P1 and P2 and determines whether the numerical values of P1 and P2 coincide with each other. If the CPU 103 determines that the numerical values of P1 and P2 do not coincide with each other (NO in step S605), then in step S606, the CPU 103 sets “1” to the clock error register 505. On the other hand, if the CPU 103 determines that the numerical values of P1 and P2 coincide with each other (YES in step S605), the CPU 103 terminates the determination processing of the flowchart illustrated in FIG. 6 without rewriting the numerical value of the clock error register 505.

The numerical value of the clock error register 505 illustrated in FIG. 5A is the value “0” initialized when the VSync signal 401 is input. The numerical value of the clock error register 505 is set to “1” in response to the input of the HSync signal 402, only when the numerical value of P1 does not coincide with the numerical value of P2. If the numerical value of P1 coincides with numerical value of P2 at the input timing of each HSync signal, the CPU 103 does not update any numerical value.

Accordingly, even when the Hsync signal 402 is input for each of the reading requested lines, the numerical value of the clock error register 505 is held (not changed) unless the VSync signal 401 for the next reading operation is input. If it is determined that the numerical value of the “number of read pixels” register 503 is equal to the numerical value of the “number of 1-line pixels” register 501, as a result of the “number of read pixels” comparison processing, the CPU 103 counts up the numerical value of the “number of read lines” register 504.

FIG. 5A illustrates correct register values at the completion timing of the 1-line reading operation. The CPU 103 performs the reading operation by repeating similar processing for each of the reading requested lines.

FIG. 4B is a timing chart illustrating an abnormal HSync signal 404 that has been input due to the influence of noise before the Sclk signal 403 corresponding to each of the reading requested pixels is input to the image processing ASIC of the image processing unit 111.

In FIG. 4B, after an initial HSync signal 405 is input, the transfer of image data begins in response to a Sclk signal 403(B). At the input timing of the abnormal HSync 404, the numerical value of a “number of read pixels” register 509(B) becomes “4.”

Accordingly, a “number of read pixels” register 508(B) at the input timing of the abnormal HSync 404 becomes “4” and then, as a result of the “number of read pixels” comparison processing, the numerical value “1” is set to the “clock error” register.

Further, when the numerical value of the “number of read lines” register 504 becomes equal to the numerical value of the “number of reading requested lines” register 502 at the time that the HSync signal is received, the CPU 103 determines that the reading operation has been completed normally and sets the numerical value “0” in the status register 512. Further, if a clock error occurs, the CPU 103 sets 1 to the status register 512 at the occurrence timing and notifies the occurrence of the error.

Through the above-mentioned processing, the signal abnormality detection in a reading operation can be realized. The signal abnormality detection described in the exemplary embodiment includes counting up the numerical values of the “number of read pixels” register and the “number of read lines” register in starting a reading operation.

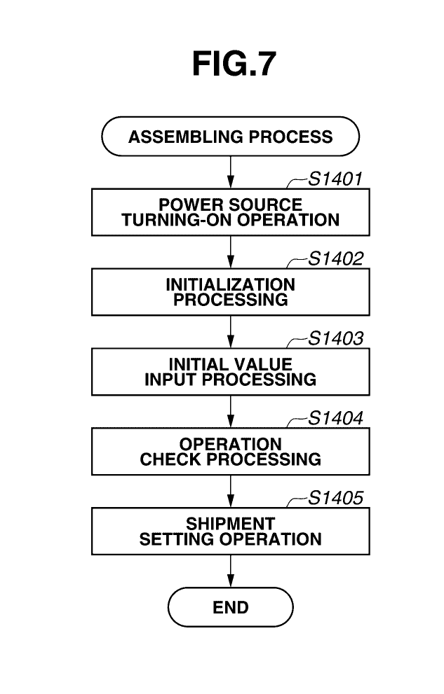

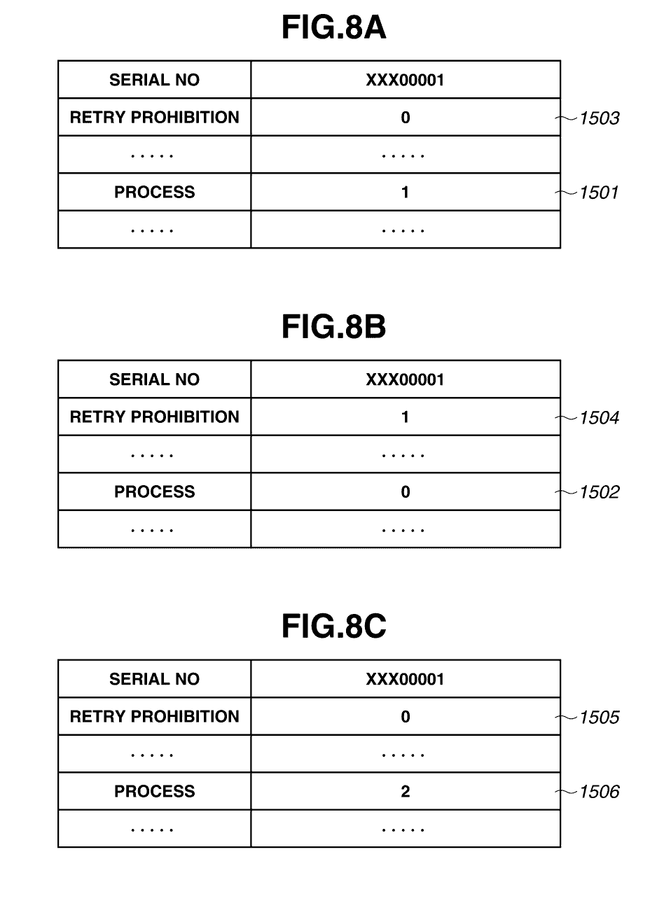

Another employable detection system is countdown type detection, which includes causing the “number of read pixels” register to latch the numerical value of the “number of 1-line pixels” register at HSync signal input timing and counting down the value when the Sclk signal is input and then determining whether the value is equal to 0 when the next HSync signal is input. Hereinafter, reading error processing will be described in detail below with reference to a flowchart illustrated in FIG. 7 and screen examples illustrated in FIGS. 8A to 8C.

In the present exemplary embodiment, the job type in a reading operation is direct transmission mode reading processing. However, the present invention does not intend to limit the applicable range to the direct transmission mode reading processing. In implementing a specific job, the CPU 103 refers to job information generated in the RAM 104 and switches the reading error processing with reference to the acquired information. Therefore, the present invention is applicable to another mode (e.g., FCOT mode) or any other reading operations in which the reading processing and the output processing are synchronously performed.

FIG. 7 is a flowchart illustrating a method for controlling the image processing apparatus according to an embodiment, which is an example of initialization processing and an operation check to be performed after the assembling of an image forming apparatus is completed in a factory according to the present exemplary embodiment, for example. To realize processing in each step, the CPU 103 executes the control program stored beforehand (i.e., a firmware). In the following description, the control firmware (hereinafter, simply referred to as “firmware”) serves as a main controller unit.

It is assumed that a worker in a manufacturing factory performs a power source turning-on operation. After the power source is turned on, the control firmware running on the CPU 103 performs almost all of the entire operation. If necessary, the worker can input an instruction via a terminal device, such as a personal computer (PC), at appropriate timing to designate an operation to be performed by the firmware of the image forming apparatus.

After the assembling of the image forming apparatus has been completed (namely, in step S1401), the power source of the image forming apparatus is turned on. Following the turning-on operation of the power source of the image forming apparatus, the firmware stored in the ROM 102 is loaded into the RAM 104 and executed by the CPU 103. The firmware detects an initially activated state by checking the presence of the configuration file in the storage memory 105.

If the presence of the configuration file is not confirmed, the firmware determines that the present state is the initially activated state. Then, in step S1402, the firmware generates the configuration file. The firmware includes initial setting values to be generated in this step. At the same time, the firmware writes the numerical value “1” into a process information field of the configuration file. After the writing of the initial setting values into the configuration file is completed, then in step S1403, the firmware sets information relating to the image forming apparatus.

The setting value to be set in step S1403 is, for example, a serial number allocated to each individual image forming apparatus or a MAC address required in network communications. The above-mentioned processing can be automatically performed by the firmware or can be performed through a direct writing operation by the worker, for example, via a terminal device connected to the image forming apparatus.

FIG. 8A illustrates an example of the information stored in the configuration file after the processing in step S1403 has been completed. At this moment, the numerical value stored in a process information field 1501 is “1.” Subsequently, in step S1404, the firmware performs an operation check to determine whether the image forming apparatus is operating normally.

While the operation check includes a wide variety of check items, the contents thereof are not described in detail below because they are not related to the essential features of the present invention. A check item that determines whether a reading operation can be performed correctly is included in the operation check items to be performed by the firmware. When the operation check completes, then in step S1405, the worker performs a shipment setting operation through a terminal device on the firmware. The firmware sets the numerical value “0” in a process field 1502 with reference to shipment setting information notified via the terminal device. FIG. 8B illustrates an example of the configuration file at the completion timing of the shipment setting operation.

In the following description, unless otherwise stated, flowcharts to be executed, and control and/or screen display contents to be realized are stored in the ROM 102 or the storage memory 105 of the control unit 115 and can be processed by the firmware running on the CPU 103.

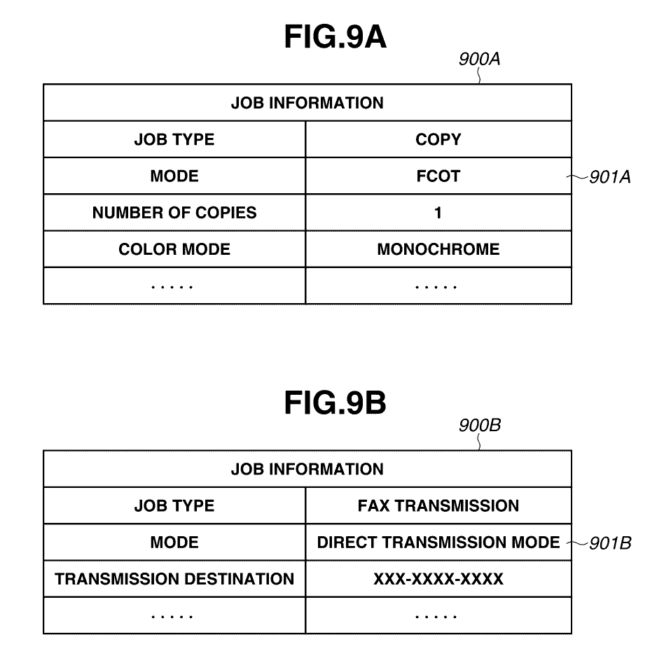

When a user performs a copy operation or a FAX transmission operation, the user can perform required settings for a copy job or a FAX transmission job via the operation unit 114. If the user completes the settings and inputs a job start instruction, the firmware generates job information illustrated in FIG. 9A or FIG. 9B and loads the generated job information into the RAM 104.

FIG. 9A illustrates an example of the job information that can be generated when the copy job is executed. The job information illustrated in FIG. 9A includes information about the FCOT mode. In generating the job information, the firmware sets the mode information by determining whether to cause the image forming apparatus to operate automatically in the FCOT mode with reference to other setting values (e.g., number of copies or color mode).

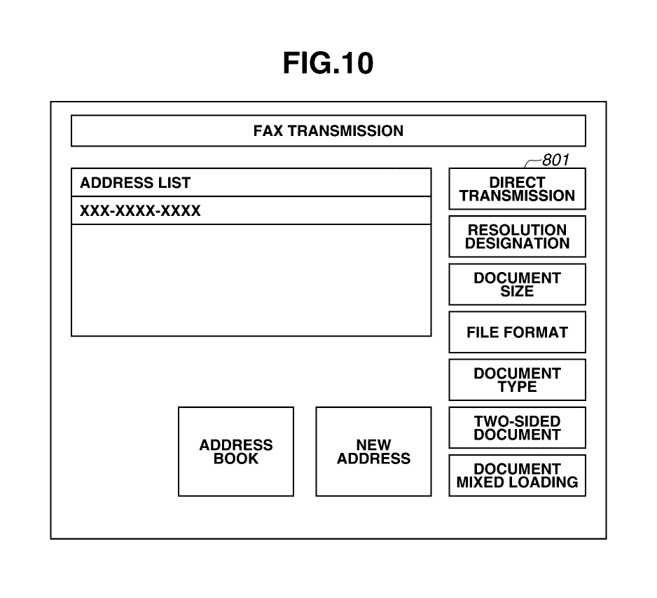

Further, FIG. 9B illustrates an example of the job information that includes a designation of the direct transmission mode. When the job to be executed is FAX transmission, the user can instruct the direct transmission mode via a UI screen illustrated in FIG. 10, which can be displayed on the operation unit 114. If the user presses a direct transmission mode key 801, a job entry designating the direct transmission mode is instructed and the key 801 is highlighted. If the user gives an instruction to execute the transmission via the operation unit 114 in the state where the key 801 is highlighted, the firmware generates the job information illustrated in FIG. 9B and starts the reading processing and the print or FAX transmission processing.

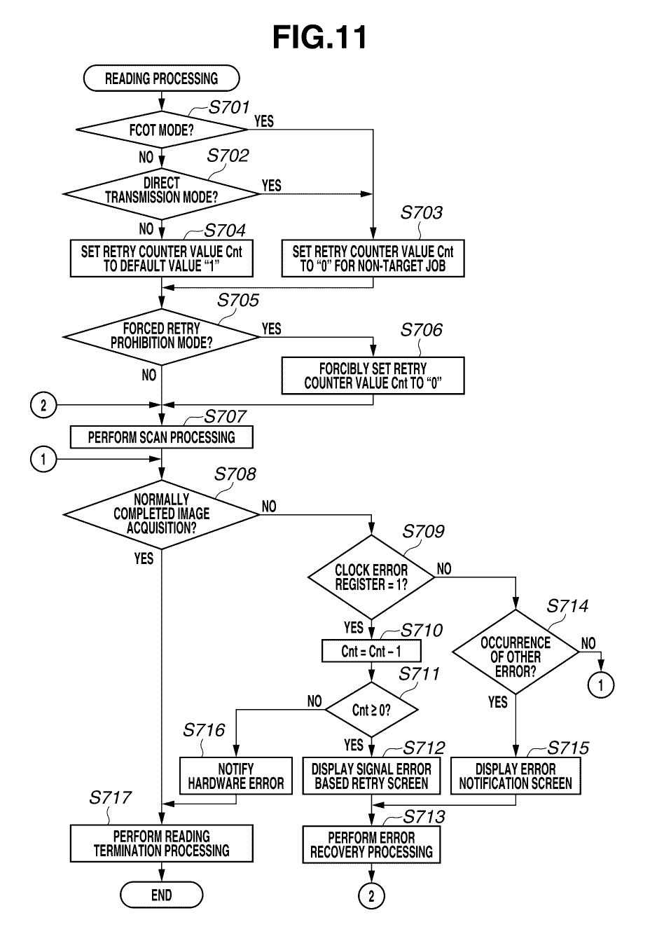

FIG. 11 is a flowchart illustrating a method for controlling the image processing apparatus according to an embodiment of the present invention, which is an example of the document reading processing according to the present exemplary embodiment. To realize the processing in each step, the CPU 103 executes the control program stored beforehand (i.e., the firmware). In the following description, the control firmware (hereinafter, simply referred to as “firmware”) serves as a main controller unit.

Further, it is assumed that image reading settings (e.g., the number of pixels, the number of lines, etc.) are determined beforehand by a control application and image reading settings required for the image processing ASIC of the image processing unit 111 are completed beforehand.

Processing for determining setting values relating to the size of each image to be read is not so related to the essential features of the present invention. Therefore, redundant description thereof will be avoided.

If the reading processing starts, the firmware performs processing for determining the number of retries that can be performed in response to an occurrence of an error. In steps S701 and S702, the firmware determines whether the designated mode is the FCOT mode or the direct transmission mode with reference to information in a mode field 901(A)/901(B) of job information 900(A)/900(B). In the present exemplary embodiment, the FCOT mode is a mode for concurrently implementing the reading processing by the reading unit 112 and the print processing by the printer unit 113.

The job information 900(A) is information about a copy job. The job information 900(B) is information about a direct transmission job. Namely, dedicated information is generated for each job.

For example, the job information 900(A) is generated when the reading processing is performed for a copy job. The job information 900(B) is generated when the reading processing is performed in the direct transmission mode.

First, in step S701, the firmware determines whether the designation in the job type field of the job information is copy. If the designation in the job type field is copy, the firmware refers to the value in the mode field. More specifically, if the designation in the job type field is “copy” and the value in the mode field is “FCOT”, the firmware determines that the designated mode is the FCOT mode. In this case (YES in step S701), the operation proceeds to step S703.

In step S703, the firmware sets the numerical value “0” as a retry counter value (Cnt) to be secured on the RAM 104.

Next, in step S702, the firmware determines whether the designated mode is the direct transmission mode. If the firmware determines that the designation in the job type field is FAX transmission and the designated mode is the direct transmission mode, the operation proceeds to step 703. The firmware sets the retry counter value Cnt to the numerical value “0.” Otherwise (NO in step S702), the operation proceeds to step S704. In step S704, the firmware sets the retry counter value Cnt to the default value “1.” Although the retry counter value Cnt is set to the default value “1” to simplify the following description,” the number of retries is not limited to one.

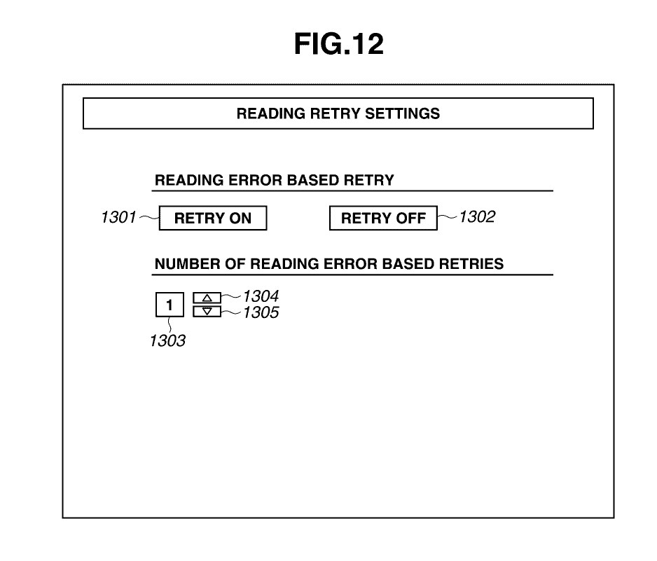

Further, the number of retries with reference to various conditions is dynamically set and is not limited. For example, a user can set the maximum number of retries on the screen of the operation unit 114. Further, dynamically changing the number of retries according to a voltage variation of the power source is feasible. As an exemplary setting screen, FIG. 12 illustrates a UI screen that enables a user to change the number of retries.

When a user changes the settings of the image forming apparatus, it is necessary for the user to perform the settings via a “user mode” screen. To display the user mode screen, the user performs a specific operation on the LCD touch panel provided on the operation unit 114. After the setting screen is displayed, the user can press a “retry ON” key 1301 or a “retry OFF” key 1302 to switch the OFF/ON state of the retry processing. The switching result can be reflected to the configuration file stored in the storage memory 105.

The user pressing the “retry ON” key 1301 explicitly expresses that the user permits the image forming apparatus to start the reading retry processing. Similarly, the user pressing the “retry OFF” key 1302 explicitly expresses that the user prohibits the image forming apparatus from starting the reading retry processing. The user can easily confirm the present retry setting (permission or prohibition) by checking whether one of the keys 1301 and 1302 is highlighted. More specifically, if the “retry ON” key 1301 is highlighted, the user can confirm that the image forming apparatus is in a retry permission state. To the contrary, if the “retry OFF” key 1302 is highlighted, the user can confirm that the image forming apparatus is in a retry prohibition state.

When the “retry ON” key 1301 or the “retry OFF” key 1302 is pressed, the firmware stores information about the present retry permission/prohibition state in the configuration file. If the “retry ON” key 1301 is pressed, the firmware sets the numerical value “0” in a retry prohibition field 1503 of the configuration file, as illustrated in FIG. 8A. On the other hand, if the “retry OFF” key 1302 is pressed, the firmware sets the numerical value “1” in a retry prohibition field 1504 of the configuration file, as illustrated in FIG. 8B.

A “number of retries” display 1303 indicates the maximum number of permitted retries, which is set to “1” as initial information about the image forming apparatus. The setting value of the maximum number of permitted retries is stored in the configuration file.

The user can press a “number-of-times increment” key 1304 to increase the setting value of the “number of retries” display 1303 from 1 to 2. The setting value of the “number of retries” display 1303 can be further increased by pressing the “number-of-times increment” key 1304.

To the contrary, the user can press a “number-of-times decrement” key 1305 to decrease the setting value of the maximum number of permitted retries. The “number of retries” display 1303 indicates the present setting value. If desired, it is feasible to restrict a settable maximum or minimum value with respect to the “number of retries”, although it is not specifically mentioned in the present exemplary embodiment.

In the present exemplary embodiment, the user act of pressing the “retry OFF” key 1302 is an explicit expression of retry prohibition. Further, the setting of the numerical value “0” as the “number of retries” can be regarded as the expression of retry prohibition.

If the setting value of the retry counter value Cnt has been updated according to the job type, then in step S705, the firmware determines whether the designated mode is a forced retry prohibition mode. The determination in step S705 can be performed by referring to retry prohibition field information stored in the configuration file.

If the setting value in the retry prohibition field is “1”, the firmware determines that the retry is prohibited. In this case (YES in step S705), the operation proceeds to step S706. In step S706, the firmware forcibly sets the retry counter value Cnt to the numerical value “0.” If the setting value in the retry prohibition field is “0”, the firmware does not change the numerical value of the retry counter value Cnt.

Further, in a case where forcibly prohibiting the retry processing in a product manufacturing process in the factory is desired, the firmware refers to information in the process field 1501 (see FIG. 8A) of the configuration file, in the determination in step S705. If the numerical value in the process field 1501 is “1”, the firmware determines that the operation check is in progress in the factory. Therefore, the operation proceeds to step S706. In step S706, the firmware sets the retry counter value Cnt to the numerical value “0.” On the other hand, if the firmware determines that the process field 1501 is “0”, the operation proceeds to the next step without changing the numerical value of the retry counter value Cnt.

After the “number of retries” setting for the retry counter value Cnt has been completed (namely, in step S707), the firmware performs scan processing. In starting the scan processing, the firmware issues a reading request including image information (e.g., the number of pixels and the number of lines) to be forwarded to the reading unit 112.

In this case, the number of pixels and the number of lines of a reading target image are set in the ASIC registers of the image processing unit 111, more specifically in the “number of 1-line pixels” register 501 and the “number of reading requested lines” register 502, respectively.

If the reading unit 112 receives the reading request, the reading unit 112 generates the sync signals VSync 401(A), HSync 402(A), and SClk 403(A) appropriately and transfers the data acquired from the photoelectric conversion element to the control unit 115.

Next, the operation proceeds to step S708. In step S708, the firmware determines whether an image has been acquired normally. In the above-mentioned determination, the firmware checks the following two points. First, the firmware checks if a reading termination notification received from the reading unit 112 indicates normal termination. Second, the firmware checks if a numerical value other than 0 is stored in the clock error register 505 and the status register 512 of the image processing ASIC of the image processing unit 111. If any one of the above-mentioned conditions is not satisfied, the firmware determines that a reading abnormality has occurred. In this case (NO in step S708), the operation proceeds to step S709. In step S709, the firmware determines whether the numerical value of the clock error register 505 is “1.” If the firmware determines that the numerical value of the clock error register 505 is “1” (YES in step S709), then in step S710, the firmware decrements the retry counter value by “1” (Cn=Cn−1).

In step S711, the firmware determines whether the retry counter value Cnt is equal to or greater than “0.” If the firmware determines that the retry counter value Cnt is equal to or greater than “0” (YES in step S711), then in step S712, the firmware causes the operation unit 114 to display a message informing that the retry processing is currently in progress due to a signal error, so that the user can surely confirm the state of the retry processing.

If the screen display of the operation unit 114 changes, the operation automatically proceeds to step S713. In step S713, the firmware performs error recovery processing. In the present exemplary embodiment, the error recovery processing includes discarding the read image data and clearing the information stored in the register groups 501 to 512 of the image processing ASIC of the image processing unit 111.

Further, the image processing ASIC of the image processing unit 111 has a function of generating an input image histogram that is usable in processing for automatically identifying the background level of a reading target document according to an image entered when the reading operation is performed.

The above-mentioned error recovery processing includes resetting histogram information generated based on the input image, so that the next reading processing can correctly start from the initial state. When the designated mode is the direct transmission mode of the FCOT mode, transmission image processing at the output side, cancellation of the image print processing, disconnection of the communication line, and discharge of supplied printing papers are performed additionally.

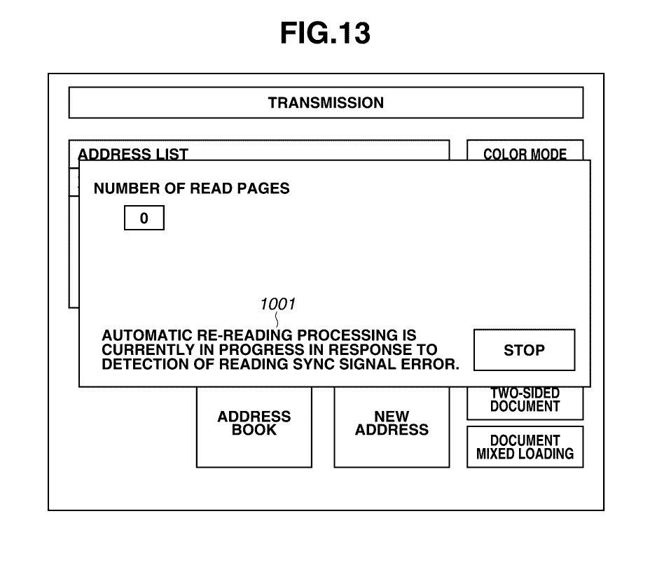

FIG. 13 illustrates an exemplary screen that can be displayed when the retry processing is currently in progress due to a signal error.

As illustrated in FIG. 13, an error processing progressing notification 1001 is additionally displayed on the ordinary scan display screen. In the present exemplary embodiment, the error processing includes an automatically commencing re-reading operation. However, it can be configured to enable a user to determine whether to perform a re-reading operation when an error occurs.

In this case, a selection key is additionally displayed on the screen illustrated in FIG. 13 so that the user can determine whether to perform the re-reading processing. If the user instructs the re-reading processing, the operation proceeds to step S713. Further, if the firmware determines that the numerical value of the clock error register 505 is “0” (NO in step S709), the operation proceeds to step 3714. In step S714, the firmware determines whether there is a reading termination notification notified by the reading unit 112. If the reading termination notification is not yet received (NO in step S714), the firmware determines that the reading processing is currently in progress. The operation returns to step S708.

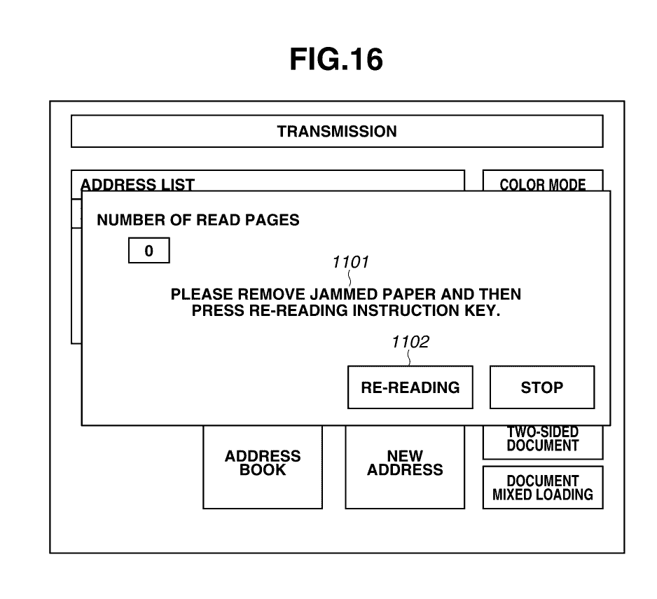

Further, if the reading termination notification is already received, the firmware checks an occurrence of other abnormality (e.g., document conveyance jam) by referring to error information included in the reading termination notification. In this case (YES in step S714), the operation proceeds to step S715. In step S715, the firmware causes the operation unit 114 to display an error notification screen that informs the necessity of appropriate action by the user. For example, the user takes action according to a jammed paper removal message 1101 displayed on an exemplary UI screen illustrated in FIG. 16. Subsequently, the user presses a re-reading instruction key 1102 to instruct the image forming apparatus to perform the re-reading processing. If the user instruction is received via the operation unit 114, then in step S713, the firmware performs the error recovery processing.

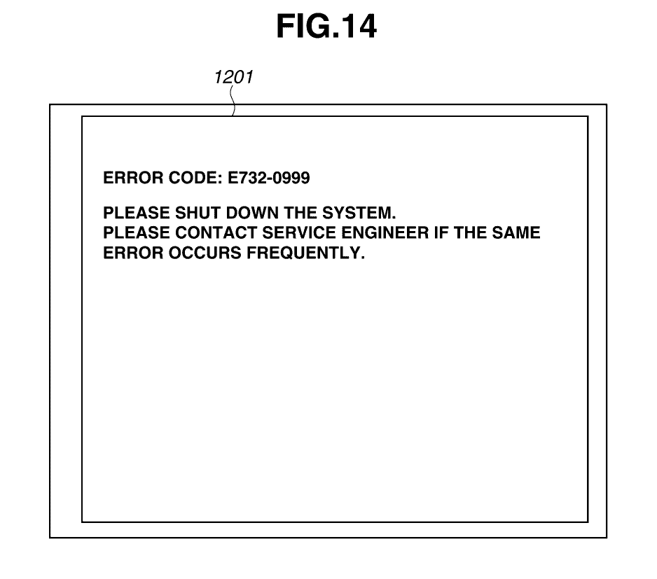

The error recovery processing to be performed after the processing in step S715 does not include the disconnection of the communication line processing and discharge of the supplied printing papers. If it is determined that the number of re-reading operations exceeds the retry counter value Cnt (NO in step S711), then in step S716, the firmware causes the operation unit 114 to display a hardware error notification screen (e.g., UI screen 1201 illustrated in FIG. 14). If normal completion of the reading processing is confirmed after the re-reading processing, the operation proceeds to step S717. In step S717, the firmware performs reading termination processing to complete the reading of one document sheet.

As mentioned above, the CPU 103 controls the image forming apparatus in such a way as to prevent the image forming apparatus from performing predetermined recovery processing if predetermined conditions are satisfied even when a reading error detected. Therefore, it is feasible to realize an image forming apparatus that does not perform useless reading processing without performing reading recovery processing endlessly while automatically performing re-reading processing when a signal abnormality is detected. Further, appropriately controlling the execution of the retry processing according to the operational environment is feasible by prohibiting the retry processing, for example, considering user settings or shipment state requiring operation check in the factory.

The control described in the present exemplary embodiment is the countdown type, in which the upper-limit value being set for the number of retries is stored in the RAM 104 and is successively decremented every time the image forming apparatus performs the re-reading processing. Alternatively, it is feasible to employ a count-up type control according to which the counter value is counted up every time the image forming apparatus performs the reading processing and the counter value is compared with the retry counter value Cnt stored in the RAM 104.

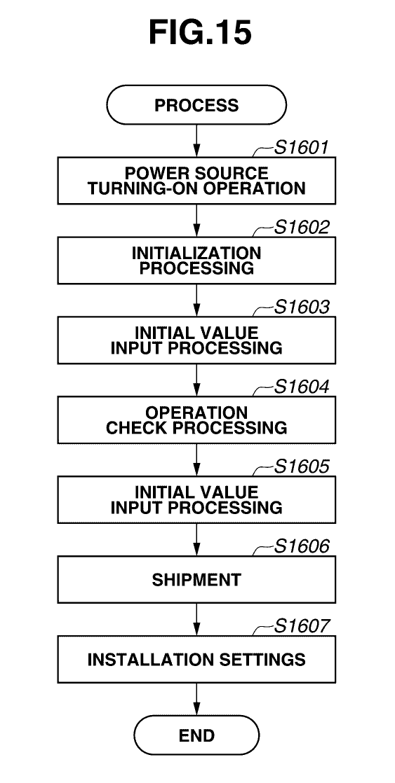

Further, performing ON/OFF switching of the re-reading processing in the factory shipment state is just one example of the present exemplary embodiment and is not intended to limit the application of the invention to only the shipment in a factory. For example, the present invention is applicable to a product in a situation where the product is shipped from a factory and installed on a designated user site and then a service engineer performs initial setup settings for the product, as illustrated in FIG. 15.

FIG. 15 is a flowchart illustrating a method for controlling the image forming apparatus according to an embodiment, which is an example of processing to be performed in a product assembling process according to the present exemplary embodiment, for example. To realize processing in each step, the CPU 103 executes the control program stored beforehand (i.e., the firmware). In the following description, the control firmware (hereinafter, simply referred to as “firmware”) serves as a main controller unit. In FIG. 15, sequential processing in steps S1601 to S1605 is similar to that in steps S1401 to S1405 illustrated in FIG. 7 and therefore redundant description thereof will be avoided.

In step S1607 of the flowchart illustrated in FIG. 15, a service engineer performs installation settings when the image forming apparatus is installed in a user environment. Then, in step S1607, the firmware sets the numerical value “2” in a process field 1506 illustrated in FIG. 8C so that the retry function can be forcibly invalidated.

To realize the present invention, it is feasible to perform processing for supplying a program that can realize at least one of the functions of the above-mentioned embodiments to a system or an apparatus via a network or an appropriate storage medium. The processing further includes causing at least one processor of a computer provided in the system or the apparatus to read and execute the program. The present invention can be realized by ASIC or any other circuit that can realize at least one of the above-mentioned functions.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present invention has been described with reference to exemplary embodiments, it is to be understood that the invention is not limited to the disclosed embodiments. The scope of the following claims is to be accorded the broadest interpretation so as to encompass all such modifications and equivalent structures and functions.

This application claims the benefit of Japanese Patent Application No. 2015-148330, filed Jul. 28, 2015, which is hereby incorporated by reference herein in its entirety.

What is claimed is:

1. An image processing apparatus, comprising:
a reading unit configured to read a document;
a printing unit configured to print an image of the document read by the reading unit; and
a processing unit configured to perform recovery processing for recovering a reading error by the reading unit if a mode for concurrently implementing the reading by the reading unit and the printing by the printing unit is not set.

2. The image processing apparatus according to claim 1, wherein the processing unit does not perform the recovery processing for recovering the reading error by the reading unit if the mode for concurrently implementing the reading by the reading unit and the printing by the printing unit is set.

3. The image processing apparatus according to claim 1, wherein the recovery processing includes processing for causing the reading unit to read the document again.

4. The image processing apparatus according to claim 1, wherein the recovery processing includes deleting the image of the document read by the reading unit.

5. The image processing apparatus according to claim 1, wherein the recovery processing includes deleting a register value to be used to process the image of the document read by the reading unit.

6. The image processing apparatus according to claim 1, wherein the reading error by the reading unit is a clock error.

7. An image processing apparatus, comprising:
a reading unit configured to read a document;
a transmission unit configured to transmit image data representing an image of the document read by the reading unit; and
a processing unit configured to perform recovery processing for recovering a reading error by the reading unit if a mode for concurrently implementing the reading by the reading unit and the transmission by the transmission unit is not set.

8. The image processing apparatus according to claim 7, wherein the processing unit does not perform the recovery processing for recovering the reading error by the reading unit if the mode for concurrently implementing the reading by the reading unit and the transmission by the transmission unit is set.

9. The image processing apparatus according to claim 7, wherein the recovery processing includes processing for causing the reading unit to read the document again.

10. The image processing apparatus according to claim 7, wherein the reading error by the reading unit is a clock error.

11. A method for controlling an image processing apparatus that includes a reading unit configured to read a document and a printing unit configured to print an image of the document read by the reading unit, the method comprising:
detecting a reading error; and
performing recovery processing for recovering the reading error if a mode for concurrently implementing the reading by the reading unit and the printing by the printing unit is not set.

12. A computer readable storage medium storing a computer program that causes a computer to control an image processing apparatus that includes a reading unit configured to read a document and a printing unit configured to print an image of the document read by the reading unit, the program comprising:
computer-executable instructions for detecting a reading error; and
computer-executable instructions for performing recovery processing for recovering the reading error if a mode for concurrently implementing the reading by the reading unit and the printing by the printing unit is not set.
